(19) United States
(12) Patent Application Publication
(10) Pub. No.: US 2015/0139778 A1
(43) Pub. Date: May 21, 2015

(54) Wind Turbine Power Enhancement, Utilizing Convergent Nozzle and Embedded Blades

(71) Applicant: Michael C. Fong, Los Altos, CA (US)

(72) Inventor: Michael C. Fong, Los Altos, CA (US)

(21) Appl. No.: 14/540,997

(22) Filed: Nov. 13, 2014

Related U.S. Application Data
(63) Continuation-in-part of application No. 13/562,296, filed on Jul. 30, 2012.
(60) Provisional application No. 61/513,312, filed on Jul. 29, 2011.
(60) Provisional application No. 61/580,006, filed on Dec. 23, 2011.

(51) Int. Cl. F03D 1/04; F03D 3/00; F03D 7/04; F03D 3/04; F03D 1/02; F03D 7/02

(52) U.S. Cl. CPC F03D 1/04; F03D 1/02; F03D 7/0204; F03D 7/042; F03D 3/0427; F03D 3/005
USPC 415/4.4; 415/220; 415/4.5

(57) ABSTRACT

Systems are provided for increasing the power to be extracted from a wind stream by a wind turbine, including placing a duct and nozzle system, or cluster of such systems, up-stream of the wind turbine. In certain embodiments, the nozzles are convergent and the blades of the wind turbine are embedded in a narrower cylinder thereof.

### CROSS-REFERENCE TO RELATED APPLICATIONS

This application is a continuation-in-part of U.S. patent application Ser. No. 13/562,296, which claims the benefit of, and priority to, U.S. Provisional Patent Application Ser. No. 61/513,312, filed on Jul. 29, 2011, entitled “Wind Turbine Power Enhancement System,” and U.S. Provisional Patent Application Ser. No. 61/580,006, filed on Dec. 23, 2011, entitled “Cluster-Nozzle Wind Speed Amplifier System For Wind Turbine Power Enhancement,” the entire disclosures of which are hereby incorporated herein by reference.

### TECHNICAL FIELD

This subject matter relates to systems and methods for enhancing the power of a wind turbine.

### BACKGROUND

Currently, the wind turbine industry focuses its attention on designing large and efficient wind turbines and rotors to enhance the conversion of wind energy in high-wind zones into useful mechanical energy and electric power generation. The main drawback in such an approach is that along with the turbine/rotor size increase, the equipment weight also increases, thereby increasing the system cost as well as operational difficulties.

There have been several attempts to enhance the coupling of wind with wind turbines blades, so as to increase the power and efficiency of the turbines. For example, U.S. Pat. No. 4,398,096 (issued Aug. 9, 1983) describes a wind turbine which has blades inside an enclosed duct with a flared mouth. In another example, U.S. Patent Application No. 2010/0278630 A1 (published Nov. 4, 2010) describes a floating assembly of wind turbines, the turbines being inside flared ducts for concentrating and directing wind. Various other shrouds around wind turbines have been described, such as U.S. Patent Application No. 2011/0076146 A1 (published Mar. 31, 2011).

Existing designs typically do not scale well, are very material-intensive, are overly-complicated, and require major re-designs to existing standard wind turbines. What is needed, therefore, is a wind turbine enhancement which does not require costly design changes in existing wind turbines, and which may even be useful as a retro-fit to existing installation, which is scalable to both large and small turbines, and which does not require costly maintenance resulting from over-complexity.

### BRIEF SUMMARY

The present disclosure relates to various systems for wind turbine power enhancement. In a particular embodiment, a simple circular cylinder/convergent nozzle may be used to increase the local wind speed so that the wind turbine power generation can be increased even with reduction in the turbine/rotor size. In another embodiment, a cluster of circular cylinder/convergent nozzles may be used upstream of a horizontal-axis wind turbine. Cost-effective power-enhancement wind turbine system design can be achieved with these approaches, and other examples described herein.

The described approaches include a system for increasing the power to be extracted from a wind stream by a wind turbine having a one or more rotatable blades. The system includes a convergent nozzle, or cluster of convergent nozzles, each having a first cylinder including an inlet with a first cross-sectional area, and a second cylinder including an outlet with a second cross-sectional area smaller than the first, and a convergent portion coupling the first and second cylinders such that a wind stream entering the first cylinder through the inlet will exit the second cylinder through the outlet with increased air velocity. The rotatable blades are embedded in the second cylinder so as to receive a stream of air and convert said stream into usable mechanical energy.

Various additional embodiments, including additions and modifications to the above embodiments, are described herein.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted, based on this disclosure, in view of the common knowledge within this field.

In the drawings:

FIG. 1 shows a prior art wind turbine flow schematic with undisturbed wind flow.

FIG. 2 shows a wind turbine flow schematic with cylinder/nozzle flow in front of rotor blades.

FIG. 3 shows an example of an array of wind turbines with cylinder/nozzle.

FIGS. 4A and 4B illustrate examples of cylinder/nozzle configurations.

FIG. 5 shows an example of a cross-nozzle wind speed amplifier system.

FIGS. 6A-6D are various views of a convergent nozzle arrangement with embedded blades.

FIGS. 7A-7D are various view of a convergent nozzle cluster arrangement with embedded views.

### DETAILED DESCRIPTION

Various example embodiments of the present inventions are described herein in the context of enhancing the power of wind turbines.

Those of ordinary skill in the art will understand that the following detailed description is illustrative only and is not intended to be in any way limiting. Other embodiments of the present inventions will readily suggest themselves to such skilled persons having the benefit of this disclosure, in light of what is known in the relevant arts, the provision and operation of information systems for such use, and other related areas.

Not all of the routine features of the exemplary implementations described herein are shown and described. In the development of any such actual implementation, numerous implementation-specific decisions must be made in order to achieve the specific goals of the developer, such as compliance with regulatory, safety, social, environmental, health, and business-related constraints, and that these specific goals will vary from one implementation to another and from one developer to another. Moreover, such a developmental effort might be complex and time-consuming, but would nevertheless be a routine undertaking of engineering for those of ordinary skill in the art having the benefit of this disclosure.

Various approaches that may be used according to this disclosure include a wind turbine power enhancement system whereby a circular cylinder/convergent nozzle can be placed in front of the wind turbine rotor blades to increase the wind speed (kinetic energy), which can in turn increase the turbine power. Based on this concept, design optimization can be achieved with proper cylinder/nozzle design and wind turbine system array configuration. This wind turbine system design can exhibit the features that the wind turbine power can be increased considerably, even if the rotor blades and the turbine unit were reduced in size. Weight reduction characterizing this system may lead to cost reduction and ecosystem friendliness.

In conjunction with this, disclosed herein are effective wind speed amplifier systems that can be used to substantially increase the power generation for small or large wind turbines. These systems feature the use of a cluster of circular cylinder/convergent nozzles upstream of a horizontal-axis wind turbine such that the higher speed (kinetic energy) of the wind flow emanating from the nozzles may lead to higher wind turbine power generation.

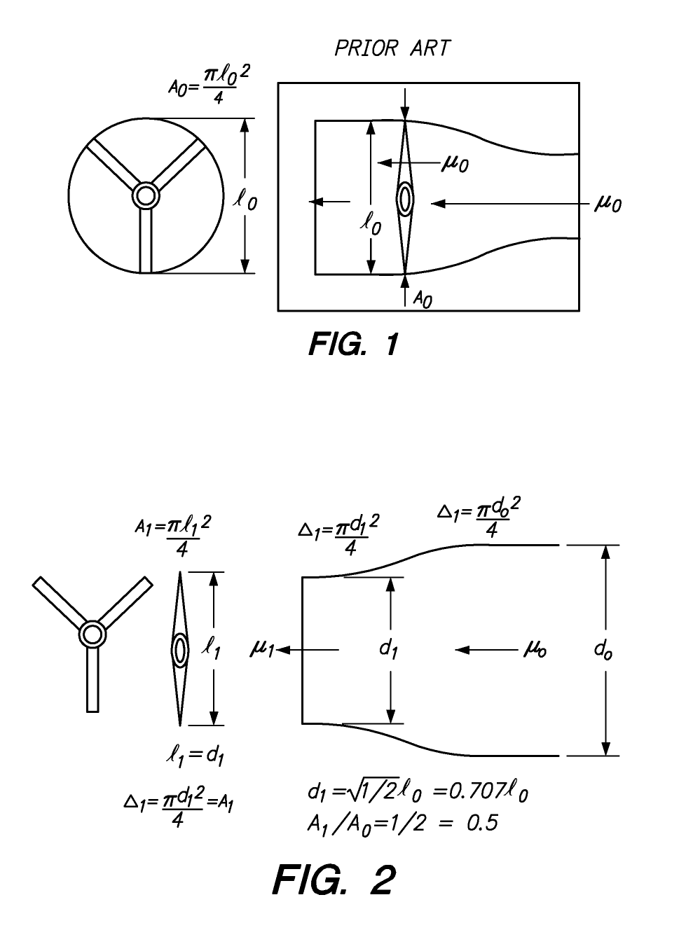

To better describe the advantages of the present inventions, FIG. 1 is provided, which describes a typical horizontal-axis wind turbine. A characteristic of such a turbine is that the power it generates is approximately directly proportional to the rotor blade flow area, but approximately proportional to the wind velocity to the third power. It can be expressed by the following equation:

P_{wo}=½ρ( 8/9Aₒuₒ³) (1)

where P_{wo} is wind-turbine generated power, ρ is air density, uₒ is undisturbed wind velocity, and Aₒ is rotor blade flow area (not rotor blade surface area), which equals π/ₒ²/4, with lₒ being the rotor blade flow diameter. Under standard conditions, Equation (1) can be written as:

P_{wo}=0.3837Aₒuₒ³ (2)

It can be seen from Equation (2) that P_{w} is more strongly affected by u than by A because of its third power effect of u. The approach is through a method to increase wind velocity to enhance the wind turbine power generation.

In one inventive embodiment described herein, (FIG. 2) a properly configured circular cylinder/convergent nozzle or system of nozzles may be placed just upstream of the turbine rotor blades, such that the airflow velocity at the convergent nozzle exit will be higher than the undisturbed wind velocity uₒ by virtue of the mass conservation law, as follows:

ρₒuₒΔₒ=ρₗuₗΔₗ (3)

where subscript o represents undisturbed wind conditions, subscript 1 represents conditions at the convergent nozzle exit, and Δᵢ is nozzle entrance or exit area. Then we have

$${u}_{1} = {u}_{o} \frac{{Δ}_{o}}{{Δ}_{1}} \qquad ( 4 )$$

where Δᵢ=πdᵢ²/4, with dᵢ being the cylinder entrance diameter dₒ or the nozzle exit diameter d₁, and ρ being no longer present because ρₒ=ρ₁ (incompressible). For ΔₒΔ₁, we have u₁>uₒ, and the kinetic energy of a cylinder/nozzle air flow experienced by the rotor blades will be higher than that under undisturbed wind flow conditions. Then, the wind turbine powers with and without the cylinder/nozzle can be related as

$${P}_{w 1} = ( \frac{{A}_{o}}{{A}_{1}} ) {( \frac{{u}_{1}}{{u}_{o}} )}^{3} {P}_{wo} . \qquad ( 5 )$$

It should be mentioned that for our model, A₁ (effective rotor flow area) is set to be equal to Δ₁ (nozzle exit area). (Note: the rotor blades can be set at, or just inside, the nozzle exit.) By varying the values of A and the cylinder/nozzle area ratio, Δ₁/Δₒ, parametric analyses can be performed to arrive at an optimum cost-effective power-enhancement wind turbine system.

As an example, we consider a sample problem where the rotor blade flow area is assumed to be one half of its original area, i.e., A₁/Aₒ=½=0.5 which leads to d₁/lₒ=l₁/lₒ=(½)^{1/2}=0.707; and the nozzle exit area is also one half of the cylinder entrance area, i.e., Δ₁/Δₒ=½=0.5 (FIG. 2). Then, from Equation (3), we have u₁/uₒ=2 and u₁³/uₒ³=8. It follows from Equation (5) that we have

P_{w1}=(½)(8)P_{wo}=4P_{wo}. (6)

This sample problem exhibits a very remarkable finding, in that although the rotor blade length is reduced by a factor of 2, the power generated by the modified wind turbine system is actually increased by a factor of 4 because of the increase in kinetic energy by using a convergent nozzle with an area reduction factor of 2.

A variety of embodiments can be realized by implementing the concept of a wind turbine system design with a circular cylinder/convergent nozzle appendage. Since the major advantage of the inventive descriptions designed herein is reduction in the overall wind turbine system weight (hence, also reduction in cost), analyses can be carried out in terms of the three key parameters, rotor blade flow diameter, nozzle area ratio, and nozzle to rotor blade distance to arrive at an optimal cost-effective system commensurate with the company's budget situation.

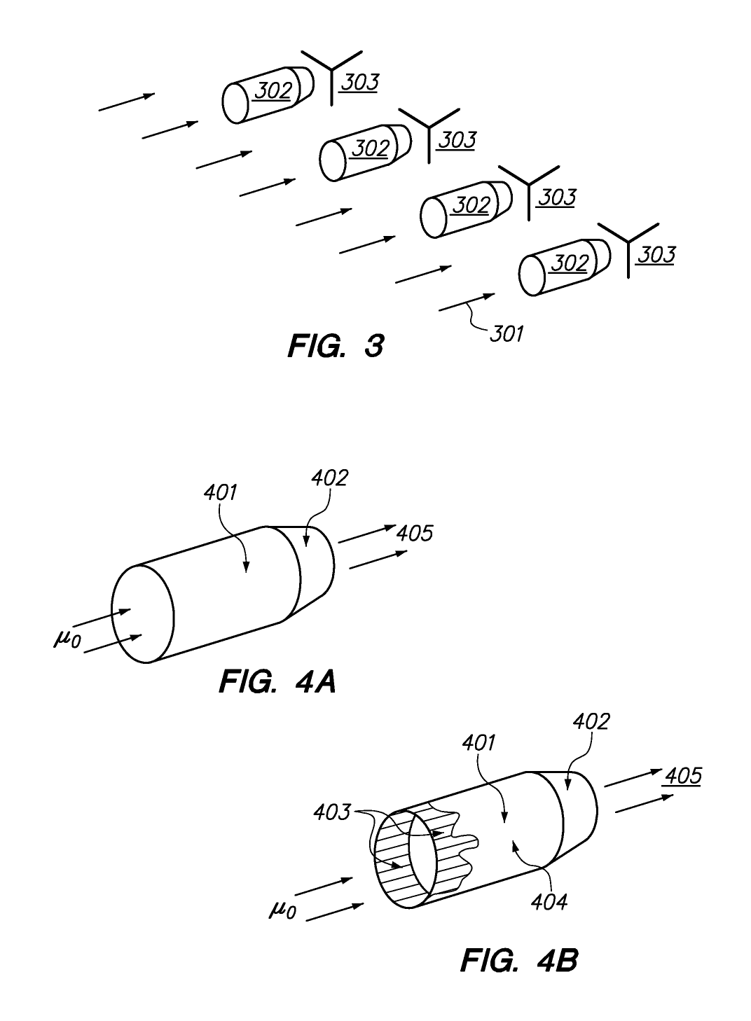

One concern for the present system is aesthetics, in that a large cylinder/nozzle in front of a similarly large wind turbine may render the landscape unappealing. Hence, in one embodiment, the system design may consider using an array of smaller systems in lieu of a large system to generate an equivalent or higher power. An example system with arrays of medium-sized wind turbine units, as schematically shown in FIG. 3. In this embodiment, the wind direction is indicated by 301, and an array of cylinder nozzles 302 is provided in advance of wind turbines 303. This array can avoid creating an unsightly scene comprising large cylinder/nozzle structures dotting the countryside.

A cylinder/nozzle design should be simple and straightforward in light of the present disclosure. In one embodiment, as shown in FIG. 4A, the nozzle may consist of a cylinder 401, connected to a convergent nozzle 402. The hardware may preferably be constructed with light-weight metal or plastic, or a wide variety of materials such as fiber-reinforced polymers, various composite materials, or wood. In another embodiment FIG. 4B, the cylinder can be constructed with a metal structural framework 403 with thin blanket 404, preferably composed of metal or even canvas. Wind flow is represented by u₀. It should be noted that when the nozzle exit air flow 405 reaches the rotor blades, its flow characteristics (laminar or turbulent) should not differ much from that of the undisturbed wind air flow u₀. Also, because of the relatively large cylinder/nozzle configuration in this conceptual design, the boundary layer should be thin compared with the central portion of the airflow; hence, there would be no shear layer or vortices impinging on the rotor blades.

While described in terms of a cylinder, it will be appreciated that the cross-sectional shape need not be circular, and conduits having a cross-sectional shapes that are not circular may be employed, although circularity, due to the shape assumed by the rotating fan blades of the turbine, would be preferred. The cylinder/nozzle itself may be generally referred to as a wind speed amplifier. Also, while described with respect to wind turbines for generating electricity, the invention can be used for increasing flow of other media, such as water, for generating electricity or for other applications.

In another general embodiment, a cluster of circular cylinder/convergent nozzles can be arranged in a circular ring so that the higher wind flow (i.e., higher kinetic energy) from the nozzles will impinge on the rotor blades of a horizontal wind turbine and, subsequently, result in an increase in the wind turbine power generation. Basic principles underlying the invention include that: (1) the air flow through a convergent nozzle should increase, its amplification depending on the nozzle area ratio; (2) the wind turbine power generation should be directly proportional to the turbine blade diameter, but proportional to the wind velocity to the third power. In view of the dominating factor of wind speed indicated above, it is desirable to use an external system that will create a higher wind speed environment for the wind turbine without necessarily altering the wind turbine system. This “external system” approach is expected to be cost-effective, because a low-cost cluster wind amplifier can be designed without having to redesign or modify the wind turbine system. In accordance with the description herein, a conceptual design of the wind speed amplifier system is provided to realize extensive cost-effective system designs for both small and large wind turbines.

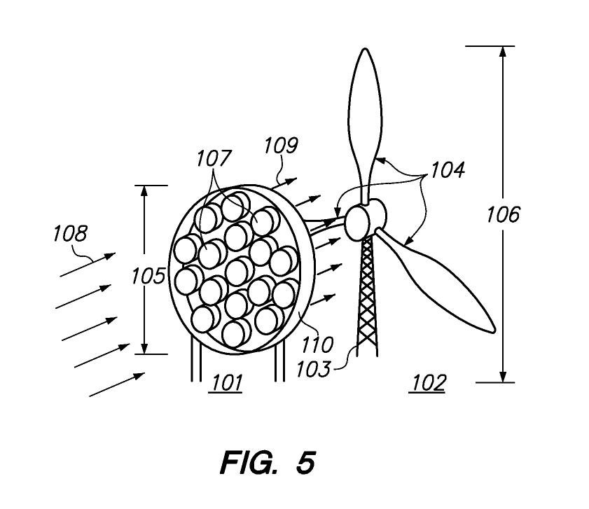

FIG. 5 describes an example of a cluster system 101 which may be used in conjunction with a wind turbine 102, including a standard wind turbine as known in the art. In this embodiment, the wind turbine includes a tower 103 and turbine blades 104. The system 101 may or may not be part of the wind turbine 102. In one embodiment, it can be an ancillary wind speed amplifier unit with its axis coincident with the wind turbine axis. It may also be a retrofit to an existing wind turbine.

The cluster system in this embodiment is characterized by flexible design, in that relatively small convergent nozzles can be employed, and the cluster assembly diameter 105 can be selected to be the same as, greater than, or a fraction of, the wind turbine diameter 106. A wide variety of materials can be used to construct the wind speed amplifier system. Most preferably, the amplifier system is composed of light-weight materials, such as carbon fiber, fiberglass, other fiber-reinforced polymers or composites, aluminum, or titanium. However, heavier and cheaper materials may also be used, such as steel, unreinforced polymers, or wood. The flexibility of design and material selection will enable this design to be a low-cost but highly effective wind speed amplifier to help enhance the power generation for small or large wind turbine systems.

In one embodiment, a basic “cluster nozzle” system may be used, which places a number of cylindrical cylinder/convergent nozzles 107 in a circular ring or band 110 facing the turbine blades 104 such that an undisturbed wind stream 108 may enter the nozzles, and the higher wind speed air flow 109 emanating from the clustered nozzles may create higher wind turbine power. The number and configuration of the nozzles may depend on the turbine size and requirements.

If a single circular cylinder/convergent wind speed amplifier system is used, the unit can be very large for a large wind turbine, thereby giving rise to weight, maintenance, aesthetic and cost problems. On the other hand, relatively small nozzles for a cluster nozzle system can achieve the same or higher wind speed with proper nozzle design and selection of the number of nozzles placed upstream of the turbine blades (FIG. 5). The higher-speed wind air streams emanating from these discrete nozzles may expand somewhat but eventually coalesce to form an essentially uniform flow impinging on the turbine blades. Although these nozzle flows could cause shear layer interaction and even vortex generation, severe adverse flow effects are not expected in a low subsonic environment encountered here. By using multiple nozzles with proper area ratios, the resulting high-speed wind flow can be made equivalent to that from a large single nozzle. Also, although the basic configuration of the cluster system comprises circular cylinders and convergent nozzles, rectangular slot nozzles, or hexagons. Two-dimensional channels, etc. can also be used to achieve high-speed wind flow generation.

In all the above embodiments, a vertical wind turbine system may be substituted for a horizontal system.

A wind monitor system (wind anemometer and wind vane) can be incorporated in the cluster-nozzle wind speed amplifier system so that the amplifier axis will always parallel the horizontal wind turbine axis (wind direction). For a vertical wind turbine system, the wind speed amplifier can be adjustable to be always aligned with the wind direction. The wind monitor subsystem can be important to minimizing the adverse cross wind effects on wind turbine power generation.

It is natural to acknowledge that the cluster ring diameter should preferably be of the same size as (or larger than) the wind turbine blade total length. However, for very large turbine blades, such as 100-ft or longer blades used on some large offshore wind turbines, the cluster ring with its diameter being of the blade length would likely create weight, maintenance and cost problems. In this case, a projected cluster area that only partially covers the wind turbine blade area could be used to achieve a cost-effective wind speed increase result. It should be noted that partial covering would induce a higher-speed air flow over part of the turbine blade surface (air foil), thereby causing a higher lift over part of the blade and higher average lift over the whole blade. Hence, a “partial covering” cluster system could still enhance the wind turbine power generation substantially, depending on the nozzle design and the cluster size.

For all of the above systems, a wide variety of materials can be used, provided their structural strength and durability are suitable for long-time operation in local environment. Materials such as sheet metal, aluminum, plastic, and graphite epoxy can all be considered.

A significant advantage of cluster-nozzle systems as described above, as well as the other embodiments described above, is that it in one embodiment, they can be an unconnected ancillary unit and not part of the wind turbine system except for using the same wind monitor (wind anemometer and/or wind vane) to ensure that the cluster unit and the wind turbine are always aligned with each other. In this case, the wind turbine design may not be “disturbed” by the cluster unit or other amplification units; therefore, there would be no attendant cost rise. In one embodiment, the cluster unit may be aligned with the turbine by placing it on a bearing or bearings so as to allow for movement and/or rotation. Preferably, this movement and/or rotation will be mechanized and automatically controlled, based on the direction and/or speed of the wind. Alternatively, control surfaces may be provided so that the alignment will take place as a result of the passage of wind across the control surfaces. This alignment system may be used both for the cluster described above, or for the other embodiments described above such as the single-duct design.

In one embodiment, a wind power amplification unit can be situated near the wind turbine, so that the exit port from the unit faces the turbine inlet, and both the amplification unit and wind turbine may be attached to a rotatable platform. In this embodiment, the amplification unit and the wind turbine would remain in the same position in relation to each other, but the combination of the two would be capable of rotating in any direction depending upon the direction of the wind. In one embodiment, nozzle amplification units may be attached to the nose of a horizontal wind turbine. In another embodiment, the units may be attached to the wind turbine tower.

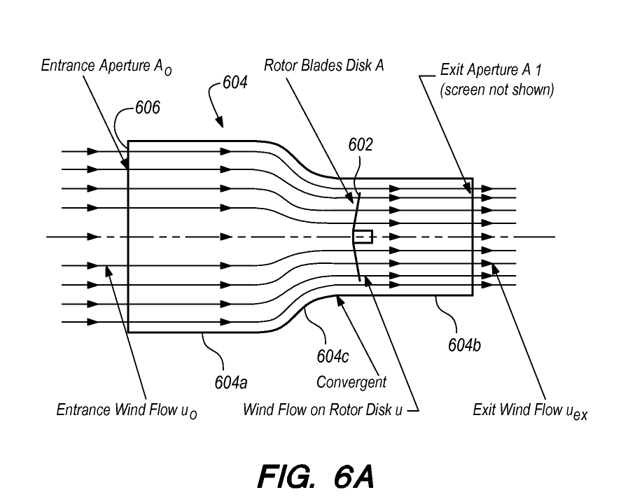

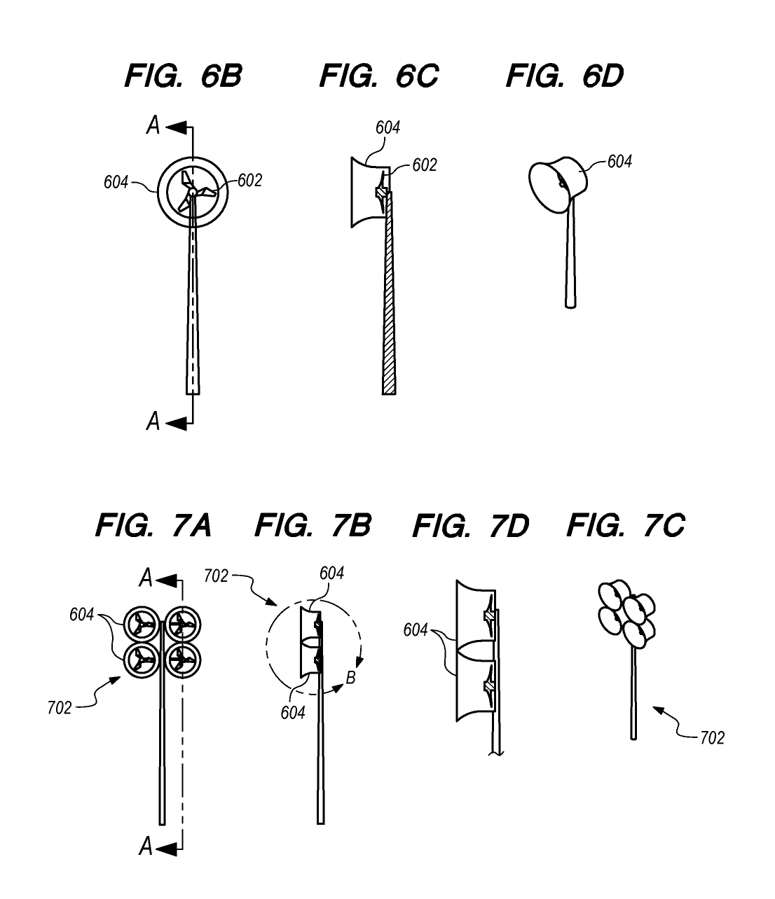

FIGS. 6A-6C and 7A-7D are directed to embodiments in which the rotor blade 602 is embedded in a convergent nozzle 604. The convergent nozzle generally comprises three parts: axially aligned cylinders 604a and 604b having different diameters, and a convergent portion 604c coupling the cylinders together. Cylinder 604a is upstream of cylinder 604b, includes inlet or entrance aperture A₀, and has a larger diameter than cylinder 604b. Cylinder 604b contains rotor blades or rotor disk 602, and has an outlet or exit aperture A₁. The cross-sectional area of the inlet is larger than that of the outlet.

Optionally, a protective screen 606 is provided at the entrance wind flow aperture. The screen 606 placed at the entrance aperture of convergent nozzle 604 is for preventing avian intrusion into the wind turbine system (a screen at the exit aperture being optional). For subsonic wind flow, the rotor blades (three or four blades) embedded in the downstream cylinder section of the convergent nozzle 604 will be subject to an enhanced uniform wind flow, which will subsequently result in an increase in wind turbine power. One advantage of the embedded configuration is that since wind turbine power is proportional to the rotor blade disc area but varies with the wind velocity to the third power, use of a convergent nozzle 604 to increase the wind velocity would be more cost-effective for wind power enhancement than that by increasing the blade length (or rotor disc area). As detailed below, even for a circular cylinder/convergent nozzle 604 with an area ratio of 0.5 and a reduced blade disk diameter by a factor of 2, the resulting turbine power would actually increase by a factor of 4 over that of the original wind turbine configuration.

In the embodiments of FIGS. 6A-6C and 7A-7D, the rotor blades 602 are embedded in the tube downstream of the convergent nozzle, where an enhanced uniform velocity is achieved. In this configuration, the rotor disk 602 is effectively isolated from ambient air and there is no interaction between the wind flow impinging on the rotor disc and external wind flow enshrouding the wind turbine, which in essence is shielded from this deleterious interaction. By comparison, in certain unembedded, unshielded configurations, the outer flow could interact with the nozzle flow, which would likely induce undesirable flow interaction effects.

In certain embodiments, a multiple-nozzle unit can be used. Such as a configuration, illustrated in FIGS. 7A-7D, multi-nozzle unit 702, is designed to avoid interactions among multiple exit flows as may be possible in the cluster embodiments described above, which could cause erratic wind speed impingement on the blades as well as wind turbine efficiency reduction. A wide spectrum of convergent nozzle/cylinder with embedded rotor configurations can be selected for efficient wind turbine application.

A linear momentum aerodynamic theory for a rotor disc embedded in an open channel, i.e., in the cylinder section just downstream of the convergent nozzle has been worked out by Houlsby, S. Draper and M. L. G. Oldfield University of Oxford Report No. OUEL 2296/08). The principal result, i.e., the power generation, P, is found to be as follows:

$$u = \frac{{A}_{o}}{{A}_{1}} {u}_{o}$$

$$P = \frac{1}{2} ρ {Au}^{3} \frac{16}{27} {( \frac{R}{R - 1} )}^{2}$$

where
P is wind turbine power
Aₒ is entrance aperture area
A₁ is cylinder area downstream of convergent nozzle
A is rotor disk area
ρ is air density
uₒ is undisturbed wind speed at entrance aperture
u is wind speed on rotor disk surface
R is area ratio, A₁/A, where A₁ is cylinder cross-sectional area.

Exemplary embodiments have been described with reference to specific configurations. The foregoing description of specific embodiments and examples have been presented for the purpose of illustration and description only, and although the invention has been illustrated by certain of the preceding examples, it is not to be construed as being limited thereby.

What is claimed is:

1. A system for increasing the power to be extracted from a wind stream by a wind turbine having one or more rotatable blades, comprising:
a convergent nozzle having a first cylinder including an inlet with a first cross-sectional area, and a second cylinder including an outlet with a second cross-sectional area smaller than the first, and a convergent portion coupling the first and second cylinders such that a wind stream entering the first cylinder through the inlet will exit the second cylinder through the outlet with increased air velocity;
wherein the rotatable blades are embedded in the second cylinder so as to receive a stream of air and convert said stream into usable mechanical energy.

2. The system of claim 1, wherein the convergent nozzle comprises metal structural members covered with a skin comprising a sheet of flexible or ductile material.

3. The system of claim 2, wherein the skin is a fabric.

4. The system of claim 1, further comprising:
means for rotating the nozzle so as to align it with the direction of the wind.

5. The system of claim 4, further comprising:
means for measuring the direction of the wind;
wherein said means for rotating the nozzle comprises one or more bearings, a motor, and an electronic control system.

6. The system of claim 1, wherein the blades are part of a vertical wind turbine.

7. A system for increasing the power to be extracted by a wind stream by a wind turbine having one or more rotatable blades, comprising:
a cluster of convergent nozzles arranged in a pattern, each convergent nozzle having a first cylinder including an inlet with a first cross-sectional area, and a second cylinder including an outlet with a second cross-sectional area smaller than the first, and a convergent portion coupling the first and second cylinders such that a wind stream entering the first cylinder through the inlet will exit the second cylinder through the outlet with increased air velocity;
wherein the rotatable blades are embedded in the second cylinder so as to receive a stream of air and convert said stream into usable mechanical energy.

8. The system of claim 7, wherein each of the convergent nozzles comprises metal structural members covered with a skin comprising a sheet of flexible or ductile material.

9. The system of claim 8, wherein the skin is a fabric.

10. The system of claim 7, further comprising:
means for rotating the cluster so as to align it with the direction of the wind.

11. The system of claim 10, further comprising:
means for measuring the direction of the wind;
wherein said means for rotating the cluster comprises one or more bearings, a motor, and an electronic control system.

12. The system of claim 7, wherein the blades are part of a vertical wind turbine.

13. The system of claim 7, wherein the cluster of comprises a hexagonal arrangement.

14. The system of claim 13, wherein said convergent nozzles within the cluster of ducts are hexagons.

15. The system of claim 7, wherein said nozzles within the cluster are rectangular slot nozzles.
